(19) United States
(12) Patent Application Publication
(10) Pub. No.: US 2025/0354498 A1
(43) Pub. Date: Nov. 20, 2025

(54) STATOR VANE WITH MULTI-ACCESS COOLING AIR FEED PASSAGE

(71) Applicant: Pratt & Whitney Canada Corp., Longueuil (CA)

(72) Inventors: Franco Di Paola, Montreal (CA); Vladimir Skidelsky, West Hartford, CT (US); Shawn M. McMahon, Laurel, MD (US); Sri Sreekanth, Mississauga (CA)

(21) Appl. No.: 18/667,803

(22) Filed: May 17, 2024

(51) Int. Cl. F01D 9/02; F01D 25/10

(52) U.S. Cl. CPC F01D 9/02; F01D 25/10; F05D 2220/32; F05D 2240/12; F05D 2260/20

(57) ABSTRACT

A stator vane is provided that includes an airfoil and a structural member. The structural member is attached to the airfoil. The structural member has a forward surface, an internal passage in fluid communication with the airfoil, and a multi-access cooling air feed passage. The multi-access cooling air feed passage includes a primary aperture in fluid communication with the internal passage and a plurality of secondary passages each configured to provide a fluid passage into the primary aperture. The primary aperture extends along a primary aperture centerline, and each secondary passage of the plurality of secondary passages extends in a direction that diverges from the primary aperture centerline.

### BACKGROUND OF THE INVENTION

### 1. Technical Field

The present disclosure relates to a gas turbine engines in general, and to cooling air passages with gas turbine engines in particular.

### 2. Background Information

Gas turbine engines typically include a compressor section to pressurize airflow, a combustor section to burn a hydrocarbon fuel in the presence of the pressurized air, and a turbine section to extract energy from the resultant combustion gases. Cooling air is passed within the gas turbine engine to cool engine components. The air used for cooling purposes may include entrained particles which may cause cooling passages to clog thereby potentially impeding the flow of cooling air. A cooling air passage configured to mitigate particulate fouling would be desirable.

### SUMMARY

According to an aspect of the present disclosure, a stator vane is provided that includes an airfoil and a structural member. The structural member is attached to the airfoil. The structural member has a forward surface, an internal passage in fluid communication with the airfoil, and a multi-access cooling air feed passage. The multi-access cooling air feed passage includes a primary aperture in fluid communication with the internal passage and a plurality of secondary passages each configured to provide a fluid passage into the primary aperture. The primary aperture extends along a primary aperture centerline, and each secondary passage of the plurality of secondary passages extends in a direction that diverges from the primary aperture centerline.

In any of the aspects or embodiments described above and herein, the structural member may be disposed on an outer radial side of the airfoil.

In any of the aspects or embodiments described above and herein, the primary aperture may include a metering portion (MP) having a MP cross-sectional area disposed perpendicular to the primary aperture centerline, and a forward portion (FP) having a FP cross-sectional area disposed perpendicular to the primary aperture centerline, and each secondary passage has a cross-sectional area, and wherein a sum of the cross-sectional areas of the plurality of secondary passages and the FP cross-sectional area is greater than the MP cross-sectional area.

In any of the aspects or embodiments described above and herein, the plurality of secondary passages may include a pair of lateral side apertures each extending at an acute angle relative to the primary aperture centerline.

In any of the aspects or embodiments described above and herein, the plurality of secondary passages may include an inner radial passage in fluid communication with the primary aperture.

In any of the aspects or embodiments described above and herein, the primary aperture may include a metering portion having a cross-sectional area disposed perpendicular to the primary aperture centerline, and each secondary passage may have a cross-sectional area and a sum of the cross-sectional areas of the plurality of secondary passages is greater than the cross-sectional area of the metering portion.

In any of the aspects or embodiments described above and herein, the stator vane may include a first support rail disposed on a first side of the primary aperture, and a second support rail disposed on a second side of the primary aperture, wherein the second side is opposite the first side, and a shield panel extending between the first support rail and the second support rail, wherein the first support rail and the second support rail extend outwardly from the forward surface, and the shield panel is disposed forward of the primary aperture. The plurality of secondary passages may include a first secondary passage defined by the first support rail, the second support rail, the forward surface, and the shield panel, and a second secondary passage defined by the first support rail, the second support rail, the forward surface, and the shield panel. The first secondary passage and the second secondary passage may be disposed on opposite sides of the primary aperture.

In any of the aspects or embodiments described above and herein, the shield panel may be free of apertures.

In any of the aspects or embodiments described above and herein, the stator vane may include a first support rail disposed on a first side of the primary aperture, a second support rail disposed on a second side of the primary aperture, wherein the second side is opposite the first side, a center support rail disposed between the first support rail and the second support rail, wherein the center support rail is bisected by the primary aperture, and the stator vane may further include a slot and a shield panel. The first and second support rails and the center support rail may extend outwardly from the forward surface, and the shield panel may extend between the first support rail and the second support rail and the shield panel may be disposed forward of the primary aperture. The slot may be disposed in the forward surface of the structural member, extending between the first and second support rails, and in fluid communication with the primary aperture. The plurality of secondary passages includes a first secondary passage may be defined by the first support rail, the center support rail, the forward surface, and the shield panel, and a second secondary passage may be defined by the first support rail, the center support rail, the forward surface, and the shield panel. The first and second secondary passages may be disposed on opposite sides of the primary aperture.

In any of the aspects or embodiments described above and herein, the stator vane may include a first slot, a second slot and a third slot disposed in the forward surface of the structural member. The first and second slots may be disposed on opposite sides of the primary aperture. The third slot may be in fluid communication with first slot, the second slot, and the primary aperture. A shield panel may extend between the first and second slots, and the shield panel may be disposed forward of the primary aperture. The plurality of secondary passages may include a first secondary passage defined by the first slot, the third slot and the shield panel, and a second secondary passage defined by the second slot, the third slot, and the shield panel. The first and second secondary passages may be disposed on opposite sides of the primary aperture.

In any of the aspects or embodiments described above and herein, the stator vane may include an aperture disposed in the forward surface of the structural member, the aperture in fluid communication with the primary aperture, and a plug received within the aperture. The plug may have a body and a cap. The body may extend axially between first and second axial ends, and may have an outer radial surface, a central bore that extends axially, and a plurality of port apertures. The plurality of port apertures may extend between the outer radial surface of the plug and the central bore. The plug may be disposed such that at least a portion of each port aperture of the plurality of port apertures extends beyond the forward surface.

In any of the aspects or embodiments described above and herein, the body of the plug may have an outer radial surface that is disposed at a plug body outer radial diameter, and the cap may have an outer radial diameter, and the cap outer radial diameter may be greater than the plug body outer radial diameter.

In any of the aspects or embodiments described above and herein, the plurality of secondary passages may include a first secondary passage defined by a first port aperture of the plurality of port apertures, and a second secondary passage defined by a second port aperture of the plurality of port apertures.

In any of the aspects or embodiments described above and herein, the primary aperture may include a metering portion having a cross-sectional area disposed perpendicular to the primary aperture centerline, the first port aperture may have a first port aperture cross-sectional area, and the second port aperture may have a second port aperture cross-sectional area, and a sum of the first port aperture cross-sectional area and the second port aperture cross-sectional area may be greater than the cross-sectional area of the metering portion.

In any of the aspects or embodiments described above and herein, the stator vane may include a center body received within the primary aperture. The center body may have a cap, a metering segment, and an end segment. The cap may have a cap outer radial surface and a plurality of port apertures disposed in the outer radial surface of the cap. The plurality of port apertures may be in fluid communication with the primary aperture and the primary aperture may have an inner diameter. The metering segment may be disposed within the primary aperture and may have a metering segment outer diameter that is less than the inner diameter of the primary aperture, thereby forming an annular region having an annular region cross-sectional area between the metering segment and the primary aperture.

In any of the aspects or embodiments described above and herein, the cap outer radial surface may be disposed at a cap outer radial diameter, and the cap outer radial diameter may be greater than the inner diameter of the primary aperture. The cap may include an aft axial surface disposed contiguous with the forward surface, and the center body may extend through the internal passage.

In any of the aspects or embodiments described above and herein, the plurality of secondary passages may include a first secondary passage defined by a first port aperture of the plurality of port apertures, and a second secondary passage defined by a second port aperture of the plurality of port apertures.

In any of the aspects or embodiments described above and herein, the first port aperture may have a first port aperture cross-sectional area, and the second port aperture has a second port aperture cross-sectional area, and a sum of the first port aperture cross-sectional area and the second port aperture cross-sectional area may be greater than the annular region cross-sectional area.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic cross-section of an example gas turbine engine architecture.

FIG. 2 is a diagrammatic cross-section of an engine turbine section.

FIG. 3 is an enlarged diagrammatic cross-section of an engine turbine section.

FIG. 4 is a perspective partial view of turbine vane illustrating a present disclosure multi-access cooling air feed passage embodiment.

FIG. 5 is a diagrammatic sectioned partial view of turbine vane showing the present disclosure multi-access cooling air feed passage embodiment depicted in FIG. 4.

FIG. 6 is an enlarged view of turbine vane showing the present disclosure multi-access cooling air feed passage embodiment depicted in FIG. 4.

FIG. 7 is a diagrammatic sectioned view of the present disclosure multi-access cooling air feed passage embodiment depicted in FIG. 4.

FIG. 8 is a perspective partial view of turbine vane illustrating a present disclosure multi-access cooling air feed passage embodiment.

FIG. 8A is a diagrammatic sectioned view of the present disclosure multi-access cooling air feed passage embodiment depicted in FIG. 8 along section line 8A-8A.

FIG. 8B is a diagrammatic sectioned view of the present disclosure multi-access cooling air feed passage embodiment depicted in FIG. 8 along section line 8B-8B.

FIG. 8C is a diagrammatic view of the present disclosure multi-access cooling air feed passage embodiment.

FIG. 8D is a diagrammatic sectioned view of the present disclosure multi-access cooling air feed passage embodiment depicted in FIG. 8C along section line 8D-8D.

FIG. 9 is a perspective partial view of turbine vane illustrating a present disclosure multi-access cooling air feed passage embodiment.

FIG. 9A is an enlarged view of the present disclosure multi-access cooling air feed passage embodiment shown in FIG. 9 with the shield panel removed.

FIG. 10 is a perspective partial view of turbine vane illustrating a present disclosure multi-access cooling air feed passage embodiment.

FIG. 10A is a section view of a present disclosure perforated plug embodiment.

FIG. 10B is a sectional view of the present disclosure perforated plug embodiment shown in FIG. 10, from the perspective of line 10B-10B as shown in FIG. 10A.

FIG. 10C is a diagrammatic sectioned partial view of turbine vane showing the present disclosure multi-access cooling air feed passage embodiment depicted in FIG. 10.

FIG. 11 is a diagrammatic sectioned partial view of turbine vane showing a present disclosure multi-access cooling air feed passage embodiment.

FIG. 11A is a diagrammatic sectional view of a present disclosure center body embodiment.

FIG. 11B is a sectional view of the present disclosure center body embodiment shown in FIG. 11A, from the perspective of line 11B-11B.

### DETAILED DESCRIPTION

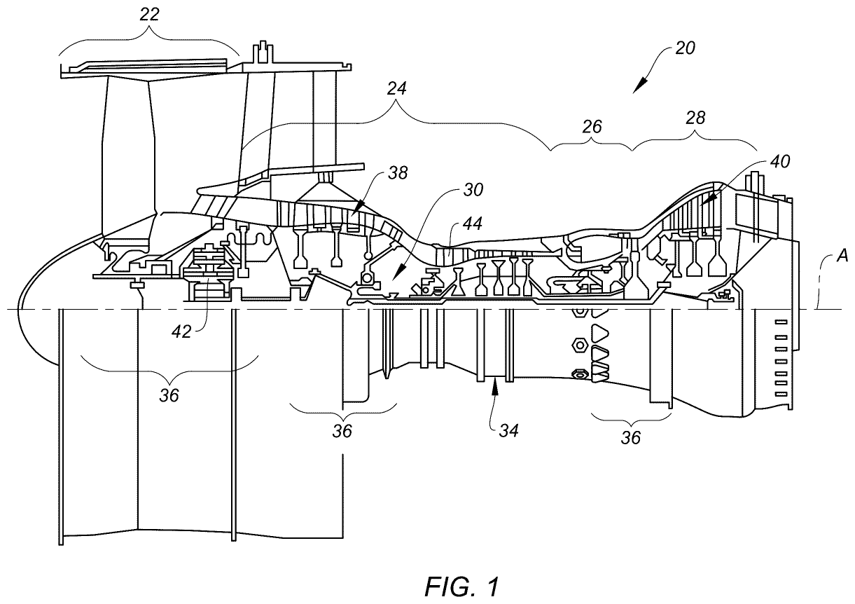

FIG. 1 diagrammatically illustrates an example of a gas turbine engine 20 that is a two-spool turbofan that generally incorporates a fan section 22, a compressor section 24, a combustor section 26, and a turbine section 28. The fan section 22 drives air along a bypass flow path while the compressor section 24 drives air along a core flow path for compression and communication into the combustor section 26 then expansion through the turbine section 28. Although depicted as a turbofan in the disclosed non-limiting embodiment, the concepts described herein may be applied to other turbine engine architectures such as turbojets, turboshafts, and three-spool (plus fan) turbofans.

The gas turbine engine 20 generally includes a low speed spool 30 and a high speed spool 32 mounted for rotation about an engine central longitudinal axis “A” relative to an engine case structure 34 via several bearing structures 36. The low speed spool 30 interconnects the fan section 22, a low pressure compressor (“LPC”) 38 and a low pressure turbine (“LPT”) 40. The low speed spool 30 drives the fan section 22 directly or through a geared architecture 42 to drive the fan section 22 at a lower speed than the low spool 30. An exemplary reduction transmission is an epicyclic transmission, namely a planetary or star gear system. The high speed spool 32 interconnects a high pressure compressor (“HPC”) 44 and high pressure turbine (“HPT”) 46. The combustor section 26 is arranged between the high pressure compressor 44 and the high pressure turbine 46. The low and high speed spools 30, 32 are concentric and rotate about the engine central longitudinal axis “A” which is collinear with their longitudinal axes.

Core airflow is compressed by the LPC 38 then the HPC 44, mixed with the fuel and burned in the combustor section 26, then the combustion gasses are expanded over the HPT 46 and the LPT 40. The turbine sections 40, 46 rotationally drive the respective low and high speed spools 30, 32 in response to the expansion. The spools 30, 32 are supported at a plurality of points by bearing assemblies 36 within the engine case structure 34.

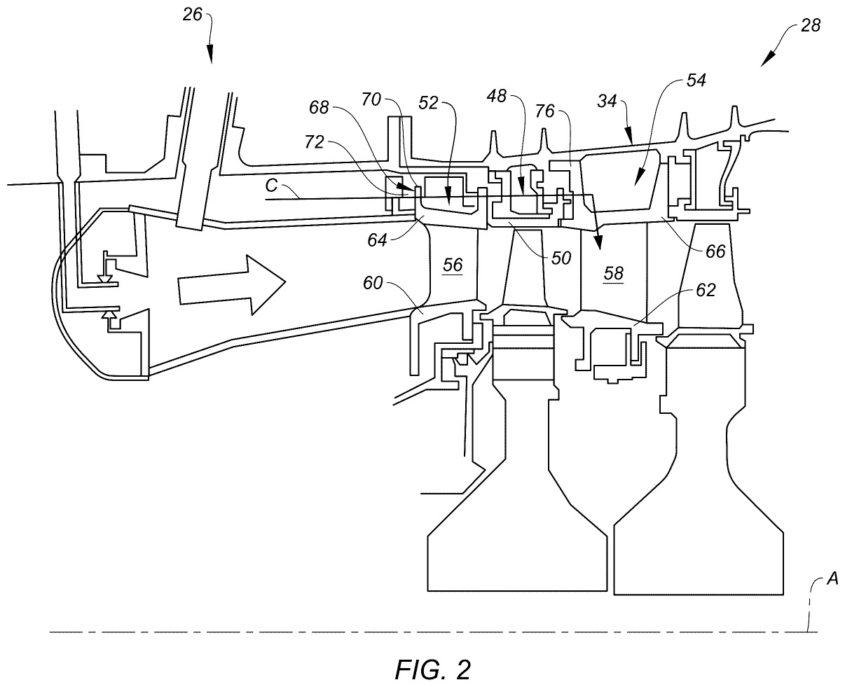

Referring to FIG. 2, an enlarged diagrammatic view of a portion of the turbine section 28 is shown by way of example; however, other engine sections will also benefit here from. A shroud assembly 48 within the engine case structure 34 supports a blade outer air seal (BOAS) assembly 50 disposed radially outside of the high pressure turbine (HPT) first rotor. The shroud assembly 48 and the blade outer air seal (BOAS) assembly 50 are axially disposed between a forward stationary vane ring 52 (e.g., the HPT inlet guide vane assembly) and an aft stationary vane ring 54 (e.g., HPT second guide vane assembly). Each vane ring 52, 54 includes an array of vanes 56, 58 that extend between a respective inner vane platform 60, 62 and an outer vane platform 64, 66. The inner vane platforms 60, 62 and the outer vane platforms 64, 66 attach their respective vane ring 52, 54 to the engine case structure 34.

The forward stationary vane ring 52 is mounted to the engine case structure 34 upstream of the blade outer air seal (BOAS) assembly 50 by a vane support 68. The vane support 68, for example, may include a rail 70 that extends from the outer vane platform 64 that is fastened to the engine case structure 34. The rail 70 includes a multitude of apertures 72 spaced therearound to communicate cooling air “C” into the vanes 56 as well as downstream thereof. Cooling air “C”, also referred to as secondary airflow, often contains foreign object particulates (such as sand). As only a specific quantity of cooling air “C” is required, the cooling air “C” is usually metered to minimally affect engine efficiency.

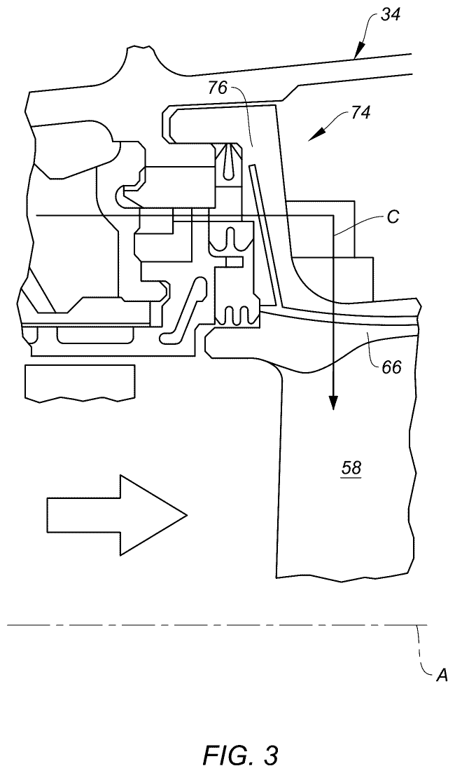

The aft stationary vane ring 54 is mounted to the engine case structure 34 downstream of the blade outer air seal (BOAS) assembly 50 by a vane support 74 (see FIG. 3). The vane support 74 extends from the outer vane platform 66 and may include an annular hooked rail 76 (also shown in FIG. 3) that engages the engine case structure 34. The annular hooked rail 76 includes a cooling air feed passage (which according to embodiments of the present disclosure is a multi-access cooling air feed passage 78) for each vane 58. The cooling air feed passage supplies the cooling air “C” to an airfoil cooling circuit (not shown) disposed within the respective vane 58. The airfoil cooling circuit may include one or more cooling air passages disposed within the airfoil of the vane, and may include a plurality of cooling apertures that allow cooling air traveling within the passages to exit an exposed surface; e.g., cooling apertures disposed in the suction side surface of the airfoil, or in the pressure side surface of the airfoil, or adjacent the leading edge of the airfoil, or adjacent the trailing edge of the airfoil, or any combination thereof. The present disclosure is not limited to any particular airfoil cooling circuit.

The terms “forward”, “leading”, “aft, “trailing” are used herein to indicate the relative position of a component or surface. As core gas air passes through the gas turbine engine 20, a “leading edge” of a stator vane or rotor blade encounters core gas air before the “trailing edge” of the same. In a convention axial gas turbine engine 20 such as that shown in FIG. 1, the fan section 22 is “forward” of the compressor section 24 and the turbine section 28 is “aft” of the compressor section 24. The terms “inner radial” and “outer radial” refer to relative radial positions from the engine centerline “A”. An inner radial component or path is disposed radially closer to the engine centerline “A” than an outer radial component or path.

Embodiments of the present disclosure include cooling air feed passages that are configured to mitigate the potential for debris clogging the cooling air feed passage. As stated above, a clogged (e.g., either completely or partially blocked) cooling air feed passage can decrease the amount of cooling air that is passed into the vane airfoil cooling circuit. A decrease in cooling air into the vane airfoil can be detrimental to the vane airfoil; e.g., detrimental to the useful life of the vane airfoil.

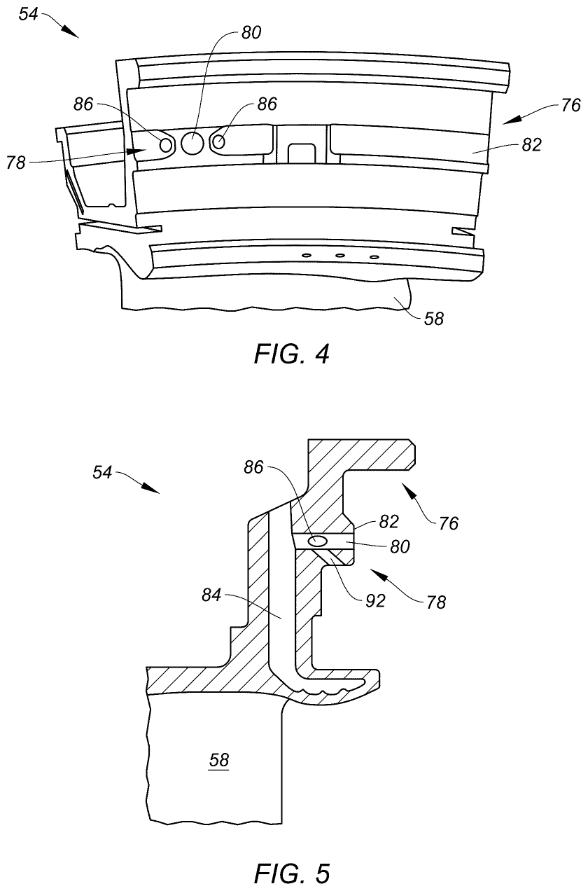

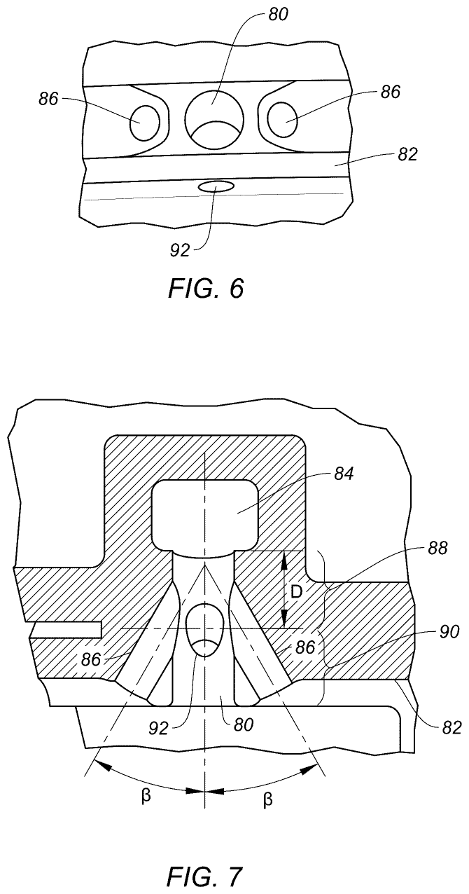

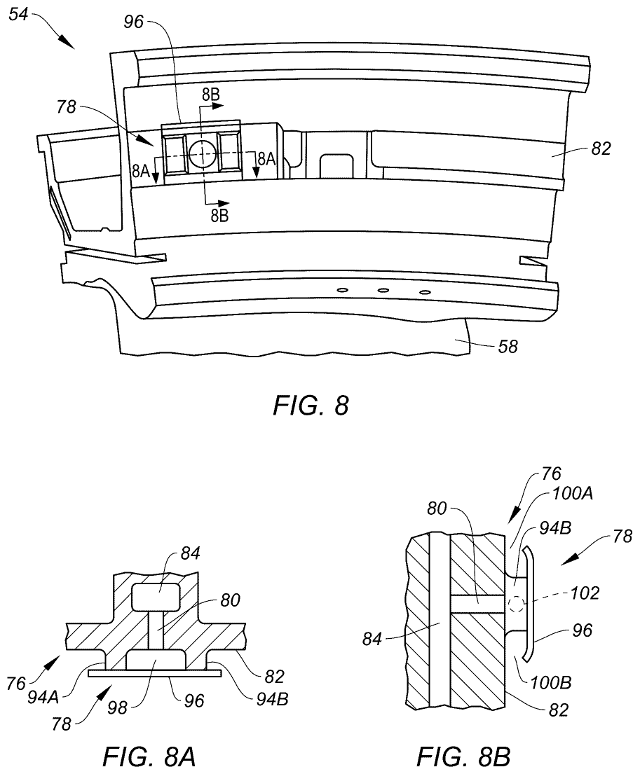

FIGS. 4-11B illustrate embodiments of a present disclosure multi-access cooling air feed (CAF) passage 78 that is configured to mitigate or prevent clogging of the same to ensure a desired amount of cooling air is provided to an airfoil cooling circuit disposed within the respective stator vane. The airfoil cooling circuit may include portions that are in fluid communication with vane structural members (e.g., components that mount the vane within stator vane ring and may be disposed outside of the core gas flow path) and/or in fluid communication with the airfoil of the vane. The present disclosure may be used with single vanes, or with structures that include more than one vane; e.g., vane doublets, vane triplets, and the like.

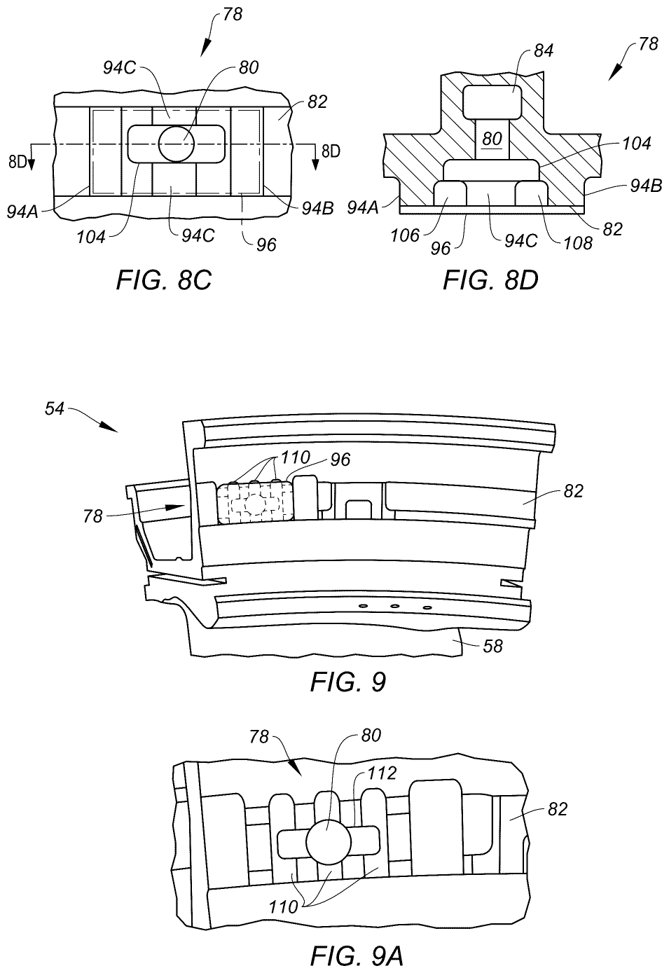

Referring to FIGS. 4-7, a first multi-access cooling air feed (CAF) passage 78 is shown that includes a primary aperture 80 that is in fluid communication with a forward surface 82 of an annular hooked rail 76 (i.e., a structural member of the vane) and an internal passage 84 that extends generally radially within the structural member. The internal passage 84 extends generally axially (e.g., parallel to the engine central longitudinal axis “A”-see FIG. 3) and is in fluid communication with the airfoil cooling circuit disposed within the vane; e.g., cooling air exiting the primary aperture 80 enters the internal passage 84 and passes into the airfoil cooling circuit. The multi-access CAF passage 78 embodiment shown in FIGS. 4-7 includes a pair of lateral side apertures 86 that intersect with and are in fluid communication with the primary aperture 80. The lateral side apertures 86 are disposed at an acute angle relative to the axis of the primary aperture 80 and are not, therefore, parallel to the primary aperture 80. In FIG. 7, each lateral side aperture 86 is shown extending along a respective axis disposed at an angle labeled “B”. The lateral side apertures 86 intersect with the primary aperture 80 a distance (“D”) from the intersection of the primary aperture 80 and the internal passage 84. FIG. 7 illustrates the primary aperture 80 as having a constant diameter but a constant diameter primary aperture 80 is not required. The length of the primary aperture 80 from the internal passage 84 to the point of the primary aperture 80 where the lateral side apertures 86 intersect may be configured to meter air flow through the primary aperture 80. This portion of the primary aperture 80 (“PA”) may be referred to as the “PA metering portion 88”. The length of the primary aperture 80 forward of the intersection of the internal passage 84 and the lateral side apertures 86 may be referred to as the “PA forward portion 90”. It should be noted that this embodiment is not limited to the PA metering portion 88 functioning as a metering device. For example, in some embodiments only a portion of PA metering portion 88 may function as a metering device. As another example, the metering function may be provided by the portion of the primary aperture that is disposed at the intersection of the primary aperture 80 and the lateral side apertures 86. The collective cross-sectional area (i.e., the plane perpendicular to the flow direction) of the PA forward portion 90 and the lateral side apertures 86 is greater than the cross-sectional area of the PA metering portion 88 (or the metering device otherwise located).

In some embodiments, this multi-access CAF passage embodiment may also include an inner radial passage 92 that extends from a front surface of the hooked rail 76 (at a position disposed radially inside of the primary aperture 80) and intersects with the primary aperture 80. As shown in FIG. 7, the inner radial passage 92 may intersect with the primary aperture 80 proximate the lateral side aperture 86 intersections. The collective cross-sectional area of the PA forward portion 90, the lateral side apertures 86, and the inner radial passage 92 is greater than the cross-sectional area of the PA metering portion 88.

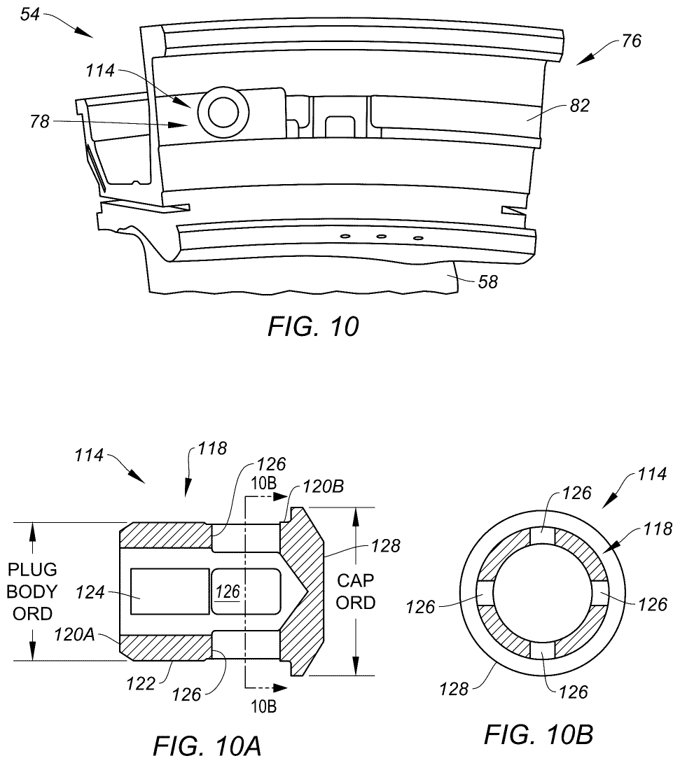

Referring to FIGS. 8-8B, another multi-access CAF passage 78 embodiment is shown that includes a primary aperture 80 that is in fluid communication with a forward surface 82 of the hooked rail 76 and the internal passage 84. In this embodiment, a first support rail 94A is disposed on a first lateral side of the primary aperture 80 and a second support rail 94B is disposed on a second lateral side of the primary aperture 80, opposite the first lateral side. The support rails 94A, 94B extend out a distance from the forward surface 82 of the hooked rail 76. A shield panel 96 extends between and is attached to the support rails 94A, 94B. The shield panel 96 is solid and does not permit air flow therethrough. The shield panel 96 and the support rails 94A, 94B form a pocket 98 contiguous with the primary aperture 80. As shown in FIG. 8B, an upper radial opening 100A is formed between the shield panel 96, the support rails 94A, 94B, and the forward surface 82 of the hooked rail 76, and a lower radial opening 100B is formed between the shield panel 96, the support rails 94A, 94B, and the forward surface 82 of the hooked rail 76. The upper and lower radial openings 100A, 100B and the pocket 98 are examples of secondary passages. The upper and lower radial openings 100A, 100B are open to permit cooling air to enter the pocket 98, and then enter the primary aperture 80, and thereafter enter the internal passage 84 before passing into the airfoil cooling circuit. The shield panel 96 disposed across the opening of the primary aperture 80 is configured to block air (and any debris entrained within the air) traveling axially from directly entering the primary aperture 80. The collective cross-sectional area of the upper and lower radial openings 100A, 100B is greater than the cross-sectional area of the primary aperture 80. Referring to FIG. 8B, in some embodiments, the support rails 94A, 94B may include an aperture 102 (shown in dashed line) that allows air to enter the pocket 98 through the support rails 94A, 94B. In an alternative embodiment (not shown), a first support rail may be disposed radially above the primary aperture 80 and a second support rail may be disposed radially below the primary aperture 80. In this embodiment, the shield panel 96 extends between and is attached to the support rails, and the shield panel 96 and the support rails form a pocket contiguous with the primary aperture 80. A first lateral opening is formed between the shield panel, the support rails, and the forward surface of the hooked rail 76, and a second lateral opening is formed between the shield panel, the support rails, and the forward surface of the hooked rail 76. The first and second lateral openings are examples of secondary passages.

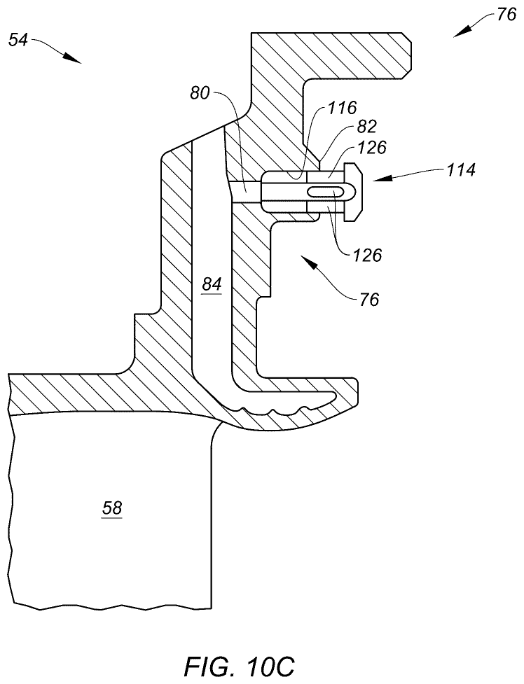

FIGS. 8C and 8D illustrate a variation of the multi-access CAF passage 78 embodiment shown in FIGS. 8-8B. In this embodiment, the multi-access CAF passage 78 includes first and second support rails 94A, 94B disposed on the respective lateral sides of the primary aperture 80, a center support rail 94C disposed between the first and second support rails 94A, 94B, and a laterally extending slot 104 that is in fluid communication with the primary aperture 80. The laterally extending slot 104 bisects the center support rail 94C and is open to the gap 106 between the first support rail 94A and the center rail 94C, and open to the gap 108 between the second support rail 94B and the center support rail 94C. A shield panel 96 extends between the first and second support rails 94A, 94B and is in contact with the first, second, and center support rails 94A-94C. FIG. 8C shows the shield panel 96 perimeter in dashed line so avoid obscuring the remainder of the configuration. Air is permitted to enter the primary aperture 80 through the gaps 106, 108 between support rails 94A-94C radially above and below the shield panel 96. In this embodiment, the gaps 106, 108 between support rails 94A-94C radially above and below the shield panel 96 and the laterally extending slot 104 form the secondary passages. The primary aperture 80 may be configured to meter air flow entering the internal passage 84. FIGS. 9 and 9A illustrate yet another example of a multi-access CAF passage 78 having a plurality of radially extending slots 110 disposed within the hooked rail 76 (in contrast to outwardly extending support rails 94A-94C that form gaps 106, 108 therebetween) in fluid communication with a laterally extending slot 112, all covered by a shield panel 96. In this embodiment, the radially extending slots 110, the laterally extending slot 112, and the shield panel 96 form the secondary passages. In an alternative embodiment (not shown), the radially extending slots may extend laterally, and the laterally extending slot may extend radially.

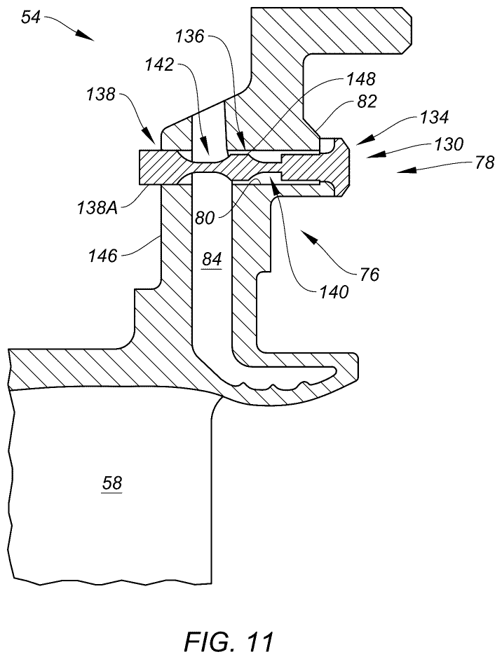

Referring to FIGS. 10-10C, another multi-access CAF passage 78 embodiment is shown. In this embodiment, the multi-access CAF passage 78 includes a perforated plug 114 disposed in an aperture 116 (se FIG. 10C) within the hooked rail 76 in fluid communication with the primary aperture 80. Referring to FIGS. 10-10B, the perforated plug 114 has a body 118 that extends axially between a first axial end 120A and a second axial end 120B. The body 118 includes an outer radial surface 122 at an outer radial diameter (“plug body ORD”), a central bore 124 that extends axially, and a plurality of port apertures 126. A cap 128 having an outer radial diameter (“cap ORD”) is disposed at the second axial end 120B. In some embodiments, the cap 128 may have a tapered outer surface portion as shown in FIG. 10A or similar configuration. The cap outer radial diameter may be greater than the body outer radial diameter; i.e., cap ORD>plug body ORD. The cap 128 is configured such that axial fluid flow is not permitted through the cap 128; i.e., the central bore 124 is closed at the cap 128 and fluid communication between the region forward of the hooked rail 76 and the central bore 124 is accomplished through the port apertures 126. Each port aperture 126 extends between the body outer radial surface 122 and the central bore 124, thereby providing a fluid passage from outside of the perforated plug 114 to the central bore 124 of the plug 114. In this embodiment, the port apertures 126 form the secondary passages. As can be seen in FIG. 10C, the perforated plug 114 is disposed within the aperture 116 disposed in the hooked rail 76. The perforated plug 114 may be fixed within the aperture; e.g., by weldment, by adhesive, by threaded engagement, by press fit, or the like. The depth of the aperture/axial length of the plug body 118 is such that the perforated plug 114 extends outwardly from the hooked rail forward surface 82 by a distance that exposes at least a portion of each port aperture 126. Axially directed cooling air encountering the perforated plug 114 is prevented from directly entering the primary aperture 80 by the plug 114, and more specifically is redirected by the cap 128. Air is permitted to enter the port apertures 126, pass into the central bore 124, subsequently pass through the primary aperture 80, and thereafter enter the internal passage 84 before passing into the airfoil cooling circuit. The primary aperture 80 may be configured to meter air flow entering the internal passage 84. The collective cross-sectional area of the port apertures 126 is greater than the cross-sectional area of the primary aperture 80.

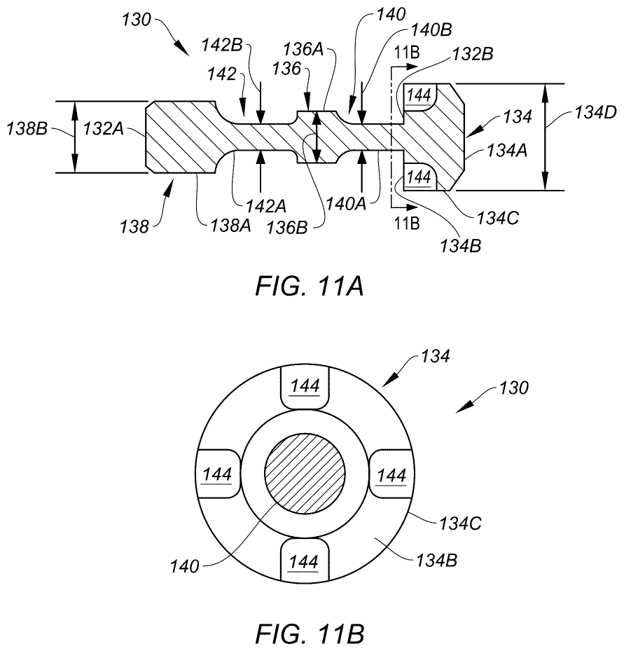

Referring to FIGS. 11-11B, another multi-access CAF passage 78 embodiment is shown. In this embodiment, the multi-access CAF passage 78 includes a center body 130 engaged with the primary aperture 80. Referring to FIGS. 11-11B, the center body 130 extends axially between a first axial end 132A and a second axial end 132B. The center body 130 includes a cap 134, a metering segment 136, an end segment 138, a first connecting segment 140, and a second connecting segment 142. The metering segment (MS) 136 has a MS outer radial surface 136A disposed at an MS outer diameter 138B. The end segment (ES) 138 has an ES outer radial surface 138A disposed at an ES outer diameter 138B. The first connecting segment (FCS) 140 has a FCS outer radial surface 140A disposed at a FCS outer diameter 140B. The second connecting segment (SCS) 142 has a SCS outer radial surface 142A disposed at a SCS outer diameter 142B. In the embodiment shown in FIG. 11A, the FCS outer diameter 140B and the SCS outer diameter 142B are equal but that is not required. In the embodiment shown in FIG. 11A, the FCS outer diameter 140B and the SCS outer diameter 142B are less than the MS outer diameter 136B and less than the ES outer diameter 138B. In alternative embodiments, the FCS outer diameter 140B and the SCS outer diameter 142B may be equal to the MS outer diameter 136B. The cap 134 includes a forward axial surface 134A, an aft axial surface 134B, a cap outer radial surface 134C, and a plurality of port apertures 144. The cap outer radial surface 134C extends between the forward and aft axial surfaces 134A, 134B. The cap outer radial surface 134C (CORS) may be disposed at a CORS outer radial diameter 134D that is greater than the ES outer diameter 138B. The port apertures 144 extend between the cap outer radial surface 134C and the aft axial end surface 134B. In some embodiments, the cap forward axial surface 134A may be tapered; e.g., as shown in FIG. 11A.

Referring to FIG. 11, the primary aperture 80 extends between the hooked rail forward surface 82 and a hooked rail aft surface 146, passing through the internal passage 84. The center body end segment 138 is sized to create a slide fit with the primary aperture inner diameter. The center body 130 may be inserted into the primary aperture 80 from the hooked rail forward surface 82 with the end segment 138 first, until the cap aft axial surface 134B is in contact with the hooked rail forward surface 82. Once fully inserted, the center body 130 is fixed within the primary aperture 80; e.g., the end segment 138 may be attached to the hooked rail 76 by weldment or adhesive, or by threaded engagement, or the like. Axially directed cooling air encountering the center body 130 is prevented from directly entering the primary aperture 80 by the center body cap 134. Air is permitted to enter the port apertures 144, pass into and travel through the primary aperture 80 in the annular regions surrounding the connecting segments 140, 142 and the metering segment 136, and subsequently enter into the internal passage 84 before passing into the airfoil cooling circuit. The collective cross-sectional area of the port apertures 144 is greater than the cross-sectional area of the annular region 148 surrounding the metering segment 136. In this embodiment, the port apertures 144 form the secondary passages. The center body 130 configuration described above is an example of an acceptable center body 130 and the present disclosure is not limited thereto.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc. The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

1. A stator vane, comprising:
an airfoil; and
a structural member attached to the airfoil, the structural member having a forward surface, an internal passage in fluid communication with the airfoil, and a multi-access cooling air feed passage;
wherein the multi-access cooling air feed passage includes a primary aperture in fluid communication with the internal passage and a plurality of secondary passages each configured to provide a fluid passage into the primary aperture, wherein the primary aperture extends along a primary aperture centerline, and each said secondary passage of the plurality of secondary passages extends in a direction that diverges from the primary aperture centerline.

2. The stator vane of claim 1, wherein the structural member is disposed on an outer radial side of the airfoil.

3. The stator vane of claim 2, wherein the primary aperture includes a metering portion (MP) having a MP cross-sectional area disposed perpendicular to the primary aperture centerline, and a forward portion (FP) having a FP cross-sectional area disposed perpendicular to the primary aperture centerline, and each said secondary passage of the plurality of secondary passages has a cross-sectional area, and wherein a sum of the cross-sectional areas of the plurality of secondary passages and the FP cross-sectional area is greater than the MP cross-sectional area.

4. The stator vane of claim 2, wherein the plurality of secondary passages includes a pair of lateral side apertures each extending at an acute angle relative to the primary aperture centerline.

5. The stator vane of claim 4, wherein the plurality of secondary passages further includes an inner radial passage in fluid communication with the primary aperture.

6. The stator vane of claim 1, wherein the primary aperture includes a metering portion having a cross-sectional area disposed perpendicular to the primary aperture centerline, and each said secondary passage of the plurality of secondary passages has a cross-sectional area and a sum of the cross-sectional areas of the plurality of secondary passages is greater than the cross-sectional area of the metering portion.

7. The stator vane of claim 6, further comprising a first support rail disposed on a first side of the primary aperture, and a second support rail disposed on a second side of the primary aperture, wherein the second side is opposite the first side, and a shield panel extending between the first support rail and the second support rail, wherein the first support rail and the second support rail extend outwardly from the forward surface, and the shield panel is disposed forward of the primary aperture;
wherein the plurality of secondary passages includes a first secondary passage defined by the first support rail, the second support rail, the forward surface, and the shield panel, and a second secondary passage defined by the first support rail, the second support rail, the forward surface, and the shield panel, wherein the first secondary passage and the second secondary passage are disposed on opposite sides of the primary aperture.

8. The stator vane of claim 7, wherein the shield panel is free of apertures.

9. The stator vane of claim 6, further comprising a first support rail disposed on a first side of the primary aperture, a second support rail disposed on a second side of the primary aperture, wherein the second side is opposite the first side, a center support rail disposed between the first support rail and the second support rail, wherein the center support rail is bisected by the primary aperture, a slot, and a shield panel;
wherein the first support rail, the second support rail, and the center support rail extend outwardly from the forward surface, and the shield panel extends between the first support rail and the second support rail and is disposed forward of the primary aperture; and
wherein the slot is disposed in the forward surface of the structural member, extends between the first support rail and the second support rail, and is in fluid communication with the primary aperture; and
wherein the plurality of secondary passages includes a first secondary passage defined by the first support rail, the center support rail, the forward surface, and the shield panel, and a second secondary passage defined by the first support rail, the center support rail, the forward surface, and the shield panel, wherein the first secondary passage and the second secondary passage are disposed on opposite sides of the primary aperture.

10. The stator vane of claim 9, wherein the shield panel is free of apertures.

11. The stator vane of claim 6, further comprising:
a first slot disposed in the forward surface of the structural member;
a second slot disposed in the forward surface of the structural member, wherein the first slot and second slot are disposed on opposite sides of the primary aperture;
a third slot disposed in the forward surface of the structural member, wherein the third slot is in fluid communication with first slot, the second slot, and the primary aperture; and
a shield panel extending between the first slot and the second slot, wherein the shield panel is disposed forward of the primary aperture;
wherein the plurality of secondary passages includes a first secondary passage defined by the first slot, the third slot and the shield panel, and a second secondary passage defined by the second slot, the third slot, and the shield panel, wherein the first secondary passage and the second secondary passage are disposed on opposite sides of the primary aperture.

12. The stator vane of claim 11, wherein the shield panel is free of apertures.

13. The stator vane of claim 1, further comprising:
an aperture disposed in the forward surface of the structural member, the aperture in fluid communication with the primary aperture; and
a plug received within the aperture, the plug having a body and a cap, wherein the body extends axially between a first axial end and a second axial end, and includes an outer radial surface, a central bore that extends axially, and a plurality of port apertures;
wherein the plurality of port apertures extend between the outer radial surface of the plug and the central bore; and
wherein the plug is disposed such that at least a portion of each port aperture of the plurality of port apertures extends beyond the forward surface.

14. The stator vane of claim 13, wherein the body of the plug has an outer radial surface that is disposed at a plug body outer radial diameter, and the cap has an outer radial diameter, and the cap outer radial diameter is greater than the plug body outer radial diameter.

15. The stator vane of claim 13, wherein the plurality of secondary passages includes a first secondary passage defined by a first port aperture of the plurality of port apertures, and a second secondary passage defined by a second port aperture of the plurality of port apertures.

16. The stator vane of claim 15, wherein the primary aperture includes a metering portion having a cross-sectional area disposed perpendicular to the primary aperture centerline, the first port aperture has a first port aperture cross-sectional area, and the second port aperture has a second port aperture cross-sectional area, and a sum of the first port aperture cross-sectional area and the second port aperture cross-sectional area is greater than the cross-sectional area of the metering portion.

17. The stator vane of claim 1, further comprising:
a center body received within the primary aperture, the center body having a cap, a metering segment and an end segment;
wherein the cap has a cap outer radial surface and a plurality of port apertures disposed in the outer radial surface of the cap, and wherein the plurality of port apertures are in fluid communication with the primary aperture;
wherein the primary aperture has an inner diameter;
wherein the metering segment is disposed within the primary aperture and has a metering segment outer diameter that is less than the inner diameter of the primary aperture, thereby forming an annular region having an annular region cross-sectional area between the metering segment and the primary aperture.

18. The stator vane of claim 17, wherein the cap outer radial surface is disposed at a cap outer radial diameter, and the cap outer radial diameter is greater than the inner diameter of the primary aperture; and
wherein the cap includes an aft axial surface disposed contiguous with the forward surface; and
wherein the center body extends through the internal passage.

19. The stator vane of claim 17, wherein the plurality of secondary passages includes a first secondary passage defined by a first port aperture of the plurality of port apertures, and a second secondary passage defined by a second port aperture of the plurality of port apertures.

20. The stator vane of claim 19, wherein the first port aperture has a first port aperture cross-sectional area, and the second port aperture has a second port aperture cross-sectional area, and a sum of the first port aperture cross-sectional area and the second port aperture cross-sectional area is greater than the annular region cross-sectional area.
